(19) United States
(12) Patent Application Publication
(10) Pub. No.: US 2026/0128417 A1
(43) Pub. Date: May 7, 2026

(54) BATTERY TEMPERATURE MANAGEMENT

(71) Applicant: QDOT TECHNOLOGY LTD, Oxford, Oxfordshire (GB)

(72) Inventors: Daniel FAHY, Oxford, Oxfordshire (GB); Jack Robert NICHOLAS, Oxford, Oxfordshire (GB); Tsun Holt WONG, Oxford, Oxfordshire (GB)

(21) Appl. No.: 19/115,970

(22) PCT Filed: Sep. 28, 2023
(86) PCT No.: PCT/GB2023/052515

§ 371 Date: Mar. 27, 2025

(30) Foreign Application Priority Data
Sep. 28, 2022 (GB) 2214227.7

(51) Int. Cl. H01M 10/6569; B60L 50/64; H01M 10/613; H01M 10/625; H01M 10/647

(52) U.S. Cl. CPC H01M 10/6569; B60L 50/64; H01M 10/613; H01M 10/625; H01M 10/647; H01M 2220/20

(57) ABSTRACT

A battery and thermal management system, which has a battery and a heat transfer arrangement. An electrical terminal extends from each of the cells in the battery, and adjacent pairs of terminals are electrically connected together. The heat transfer arrangement has an inlet channel, an outlet channel, and a plurality of heat transfer channels. The heat transfer channels are defined between respective inflow walls and outflow walls, and extend between the inlet channel and the outlet channel. There is a permeable barrier in each heat transfer channel which is slanted, so that it is positioned furthest from the inflow wall at a first end of the heat transfer channel, and closest to the inflow wall at a second end of the heat transfer channel. Each permeable barrier is in thermal contact with a connected pair of terminals along a length of the permeable barrier,

This invention relates to the thermal management of batteries, such as those used to power electric and hybrid-electric vehicles (EVs), which could include terrestrial vehicles, boats, underwater vehicles or airborne vehicles, all either manned or unmanned. They could also be used in other applications, including, but not limited to, stationary energy storage or portable energy storage. All forms of electric transport are becoming increasingly popular due to concerns over the environmental impacts of traditional fossil fuel powered engines, and the reduced environmental impact of electrically powered vehicles in comparison. Energy storage is also an increasingly important part of electricity infrastructure, on account of the intermittent nature of renewable energy sources. However, limitations to battery technology at present hinders further expansion of the use of batteries in the abovementioned applications.

One such limitation is the need to control the temperature of the battery through heating or cooling. The desired operating temperature of the batteries can be more or less than the ambient air temperature. A battery which is too cold may compromise efficiency of its operation during use, and conversely charging and discharging cycles generate heat which degrades the performance of the battery over its lifetime. Furthermore, overheating can lead to fire or power failure. Cooling is therefore an integral safety feature for the prevention of overheating, and thermal management is an important factor in improving a battery's performance and lifetime.

Pouch cells are commonly used for batteries in EVs. Pouch cells have a housing within which are a plurality of sub-cells, each composed of a negative electrical collector, an anode and cathode, separated by an ion-permeable electrode separation layer, and a positive electrical collector. An electrolyte surrounds the layers of the sub-cell. These sub-cells are layered to form a cell, with the multiple layers of electrical collectors coupled to electrically and thermally conductive electrical terminals, commonly described as tabs, which extend beyond the cell housing.

Current methods of battery cooling in EVs rely on the interface between the layers of cells being cooled as this provides the largest surface area over which to cool. The

Applicant has appreciated there are shortcomings associated with this method, in particular the temperature gradient this causes across the depth of the battery due to the poor thermal conductivity through the multiple layers within the sub cells and particularly the typically high contact resistance between respective layers. This leads to the hottest part of the battery (the centre) dictating the lifetime of the battery as a whole.

Applying a tab cooling method, where coolant flows through channels between the “tabs” and carries heat away from the battery is a known solution used to partly address the uneven cooling which can occur across the depth of each cell. However, the Applicant has appreciated that the length of a cooling channel running between the tabs results in the temperature of the coolant fluid rising along its length. This results in non-uniform heat transfer away from the battery, and as a result, an undesirable temperature gradient along the length of each pouch cell.

Temperature gradients across the cells can be lessened by increasing the flow rate of coolant. However, where driving the fluid actively, this requires greater power, or where encouraging airflow passively, this requires physically larger heat transfer features to sufficiently mitigate against temperature gradients.

From a first aspect, the invention provides a battery and thermal management system arrangement comprising a battery and a heat transfer arrangement, the battery comprising a plurality of mutually adjacent cells, each of said cells comprising an electrical terminal extending therefrom, adjacent pairs of said terminals being electrically connected together to form a connected pair;
the heat sink arrangement comprising:
   an inlet channel,
   an outlet channel, and
   a plurality of heat transfer channels defined between respective inflow walls and outflow walls, wherein the heat transfer channels extend between the inlet channel and the outlet channel;
each heat transfer channel further comprising a respective permeable barrier therein, the permeable barriers being slanted relative to the corresponding inflow and outflow walls so as to be positioned furthest from the inflow wall at a first end of the respective heat transfer channel proximate the inlet channel, and closest to the inflow wall at a second end of the respective heat transfer channel proximate the outlet channel; and, wherein each permeable barrier is in thermal contact with a respective connected pair of terminals along a length of the permeable barrier.

Thus it will be seen that, in accordance with the invention, slanted permeable barriers are positioned in each heat transfer channel. As heat transfer fluid is made to flow along the inlet channel and into the heat transfer channels, the slanted arrangement tends to cause more uniform heat transfer fluid flow through each part of the permeable barriers and so by aligning the permeable barriers with the electrical terminals, uniform cooling or heating of the battery can be achieved.

Advantageously the permeable barriers are slanted such that in use, substantially equal mass flows of heat transfer fluid pass through the permeable barrier along its length, i.e. at each point along the length of the permeable barrier, a substantially equal mass of heat transfer fluid passes through it, crossing from the inflow side of the heat transfer channel to the outflow side, as at every other point along its length. Advantageously this delivers substantially the same mass of fluid, at substantially the same temperature, to each small area of the connected pairs of terminals. This means that the battery may be cooled or heated more uniformly.

The slanted permeable barriers provide more uniform heat transfer fluid flow as they account for a cumulative reduction in mass of heat transfer fluid on the inflow side of the heat transfer channel; more of the heat transfer fluid passes through the permeable barrier at each point along its length. Therefore, the total mass of heat transfer fluid on the inflow side of the permeable barrier is maximum at the first end of the heat transfer channel proximate the inlet channel, and decreases with distance toward the second end proximate the outlet channel.

Correspondingly, the space between the permeable barrier and the outflow wall of the cooling channel varies in cross-sectional area due to the slanted barrier. Consequently, the total mass of heat transfer fluid on the outflow side of the permeable barrier increases toward the end of the heat transfer channel proximate the outlet channel, as cumulatively more fluid passes from the inflow side to the outflow side.

In a set of embodiments, the battery and thermal management system further comprises a pumping system arranged to pump a heat transfer fluid through the heat transfer arrangement from the inlet channel to the outlet channel, through the heat transfer channels. The heat transfer fluid may be a liquid, or it may be a gas such as air. Alternatively, the heat transfer fluid may be a phase-changing material, such that it changes phase passing through the heat transfer arrangement. For example, for cooling, the phase of the coolant fluid may change from liquid to gas. The pumping system may be a closed circuit, wherein the heat transfer fluid is re-cooled or re-heated and re-used following each pass through the heat transfer arrangement, or it may be an open circuit, e.g. comprising air which is drawn in from, and exhausted to the surrounding environment.

In a set of embodiments, the heat transfer arrangement is arranged such that in use, substantially equal mass flows of heat transfer fluid are distributed into each heat transfer channel. An equal mass of heat transfer fluid provided to each heat transfer channel may advantageously mean that the same capacity for heat transfer is delivered to each of the cells in the battery. In a set of embodiments, for example, the inlet channel comprises a cross-sectional area which varies between a maximum at a proximal end of the inlet channel and a minimum at a distal end of the inlet channel. This variation in cross-sectional area may allow a substantially equal portion of the fluid to be distributed into each heat transfer channel, after being pumped into the inlet channel at the proximal end, thereby further promoting uniform flow and so uniform cooling or heating across the battery.

The heat transfer channels may be spaced along the length of the inlet channel between an inlet at the proximal end of the inlet channel, and the distal end of the inlet channel. The distal end of the inlet channel may be closed, such that all fluid which is pumped into the inlet channel is distributed amongst the heat transfer channels.

The fluid typically exits the inlet channel and enters each heat transfer channel on the side of its permeable barrier proximate the inflow wall of the heat transfer channel, then passes through the permeable barrier to the side of the heat transfer channel proximate the corresponding outflow wall. The heat transfer fluid may then flow down to the second end of the heat transfer channel, where it exits into the outlet channel.

In a similar manner to the inlet channel in some embodiments, the outlet channel may comprise a cross-sectional area which varies between a maximum at a proximal end of the outlet channel and a minimum at a distal end of the outlet channel. This may achieve uniform outflow from the heat transfer channels through the outlet channel, which may help maintain uniform flow through the heat transfer channels, and thus carry heat away from the battery more effectively. The proximal end may be open, and the distal end may be closed, such that all heat transfer fluid delivered to the outlet channel exits the heat transfer arrangement through the proximal end of the outlet channel.

The heat transfer arrangement may comprise any number of inlet and outlet channels, with heat transfer channels extending therebetween. The number of inlet channels and outlet channels may be different, for example, there may be one inlet channel, and two outlet channels, with two sets of heat transfer channels situated therebetween.

The permeable barriers typically comprise a series of longitudinally spaced heat transfer features. The heat transfer fluid is made to flow from the inflow side of the permeable barrier to the outflow side, passing through the heat transfer features.

The permeable barrier may comprise only one type of heat transfer feature, or may comprise a combination of different heat transfer features. The permeable barrier may comprise any heat transfer features which allow heat transfer fluid to pass through it. Advantageously the heat transfer features are distributed along the full length of the permeable barrier.

In a set of embodiments, at least some of the heat transfer features comprise walls or protrusions, and a heat transfer fluid is made to flow through the space between adjacent protrusions.

In another set of embodiments, at least some of the heat transfer features comprise holes. The cross-sectional area of such holes may be constant at different points along the length of the permeable barrier, or it may vary.

In a set of embodiments, the heat transfer channels are arranged such that in use, the heat transfer fluid comes into direct contact with a surface of the connected pairs of terminals. The heat transfer fluid may contact the terminals whilst passing through the permeable barrier. Direct contact may improve the rate of heat transfer by avoiding intermediate layers of material. In a set of embodiments where the fluid comes into direct contract with the terminals, the fluid may impinge substantially normally onto one or more of the terminal surfaces. Impinging flow may advantageously improve the rate of heat transfer further.

In a set of such embodiments, for each heat transfer channel, an electrical terminal of a connected pair forms a first wall of the heat transfer channel, and an electrical terminal of an adjacent connected pair forms a second wall of the heat transfer channel. Each heat transfer channel may be shared between two connected pairs of terminals.

In another set of such embodiments, for each heat transfer channel, the first electrical terminal of a connected pair forms a first wall of the heat transfer channel and the second electrical terminal of the same connected pair forms a second wall of the heat transfer channel. Advantageously this provides a specific heat transfer channel for each connected pair of terminals, which may increase heat transfer rates by providing more heat transfer fluid per electrical terminal.

In another set of such embodiments, each connected pair of terminals extends through a base portion of the heat transfer arrangement such that the connected pair forms a portion of a base wall of each heat transfer channel. The portion of the base wall formed by the connected pair of terminals may be aligned with the permeable barrier such that in use, the heat transfer fluid may directly contact the terminals when passing through the permeable barrier.

In an alternative set of embodiments, the heat transfer arrangement comprises a base portion with an outer wall that the connected pairs of terminals do not extend through. In a set of embodiments where the terminals do not extend through the heat transfer arrangement, the outer wall of the base portion may be shaped to fit over the connected pairs of terminals. This may make manufacture or assembly of the battery and thermal management system arrangement more straightforward. For example, it may facilitate replacement of the battery without replacing the heat transfer system or vice versa. Additionally or alternatively, a thermally conductive gap-filling material may be used to provide thermal contact between the connected pairs of terminals and the base portion. Advantageously in such embodiments, the permeable barriers are fixed on an upper side of the base portion, and are aligned with the length of connected pairs of terminals located underneath the base portion.

Indeed, the Applicant has recognised that heat transfer systems of the kind described herein in accordance with the first aspect of the invention can be applied to any suitably designed battery and are thus useful in their own right. When viewed from a second aspect therefore, the invention provides a heat transfer system suitable for use with the battery and heat transfer system arrangement as described herein.

Features of any aspect or embodiment described herein may, wherever appropriate, be applied to any other aspect or embodiment described herein. Where reference is made to different embodiments or sets of embodiments, it should be understood that these are not necessarily distinct but may overlap.

Certain embodiments of the invention will now be described, by way of example only, with reference to the accompanying drawings, in which:

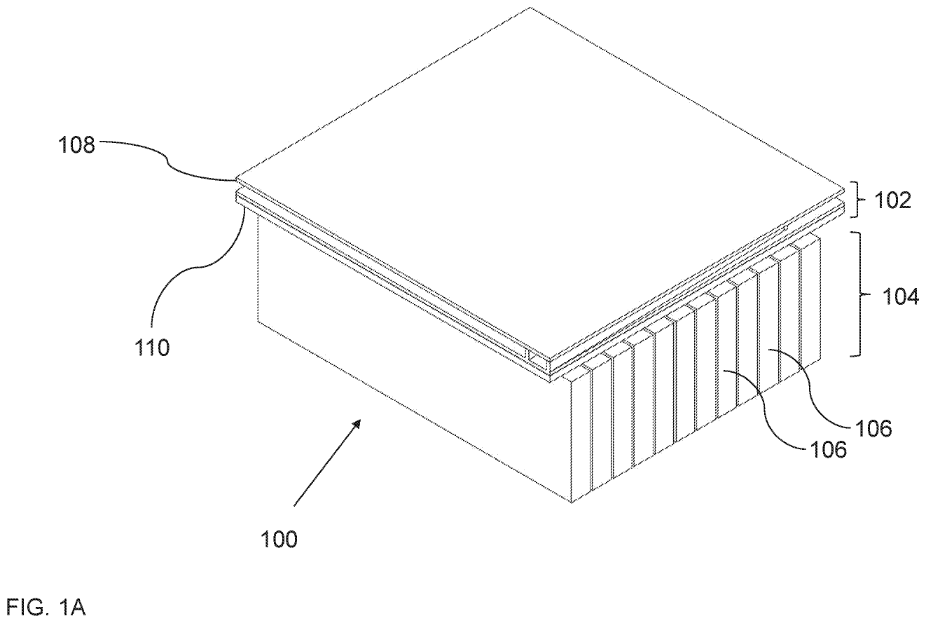

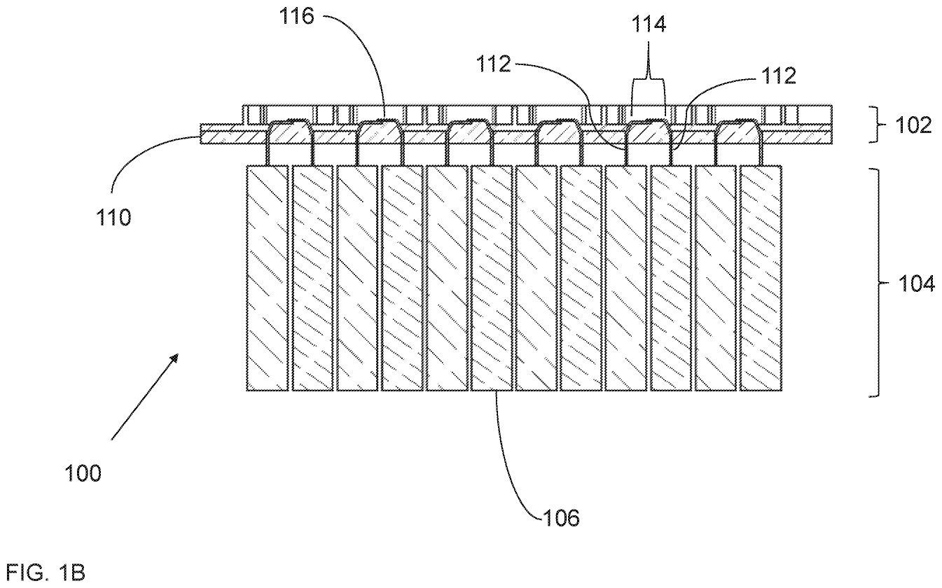

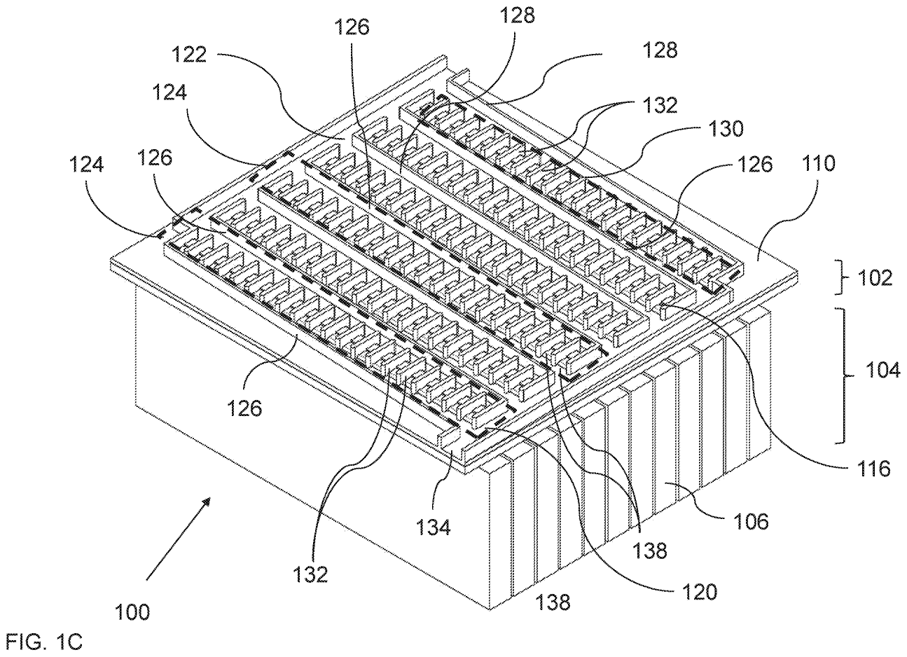

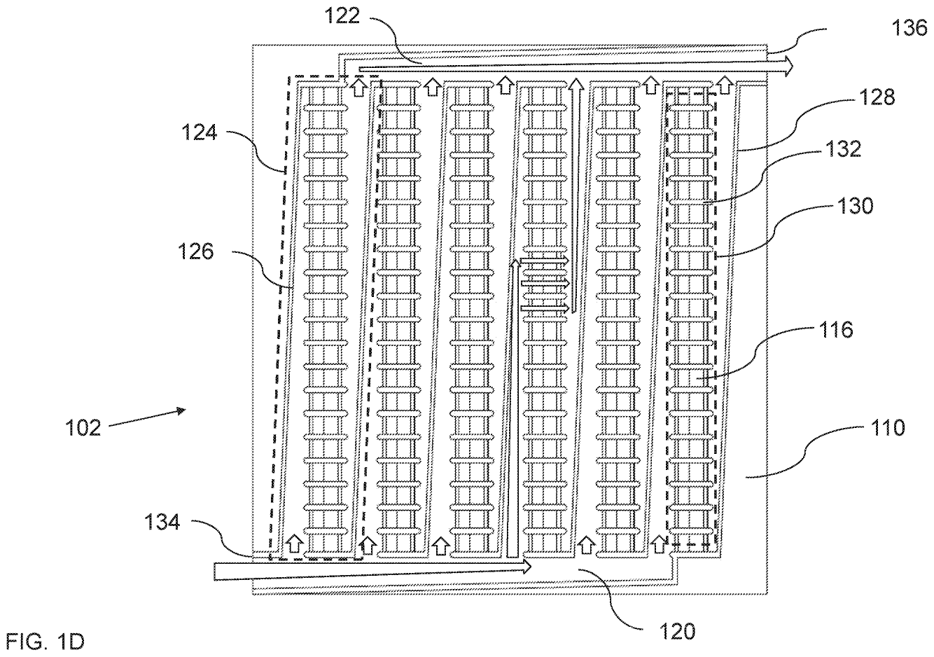

FIG. 1A is a perspective view of a battery and cooling system in accordance with a first embodiment of the present invention;

FIG. 1B is a side-on cross-sectional view of the battery and cooling system in accordance with the first embodiment of the present invention;

FIG. 1C is a further perspective view of the battery and cooling system in accordance with the first embodiment of the present invention with the upper cover removed;

FIG. 1D is a plan view of the battery and cooling system in FIG. 1C;

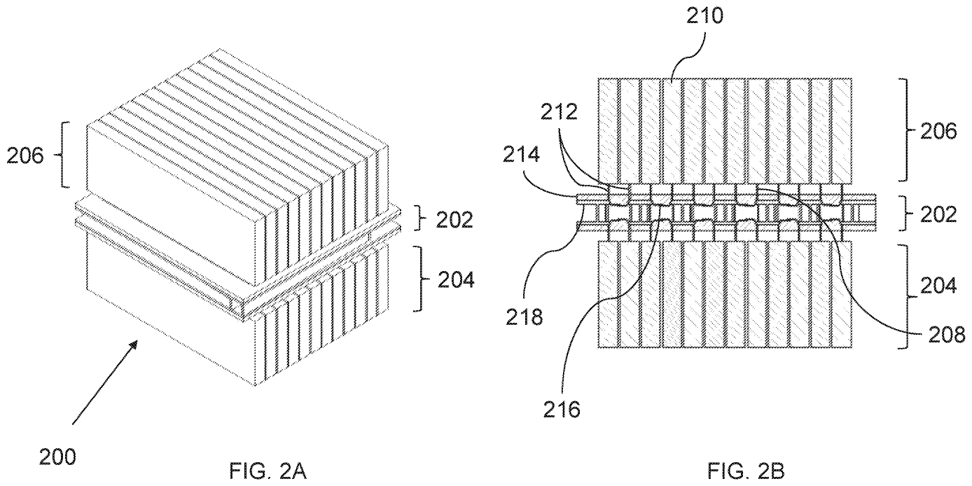

FIG. 2A is a perspective view of a battery and cooling system in accordance with a second embodiment of the present invention;

FIG. 2B is a side-on cross-sectional view of the battery and cooling system in accordance with the second embodiment of the present invention;

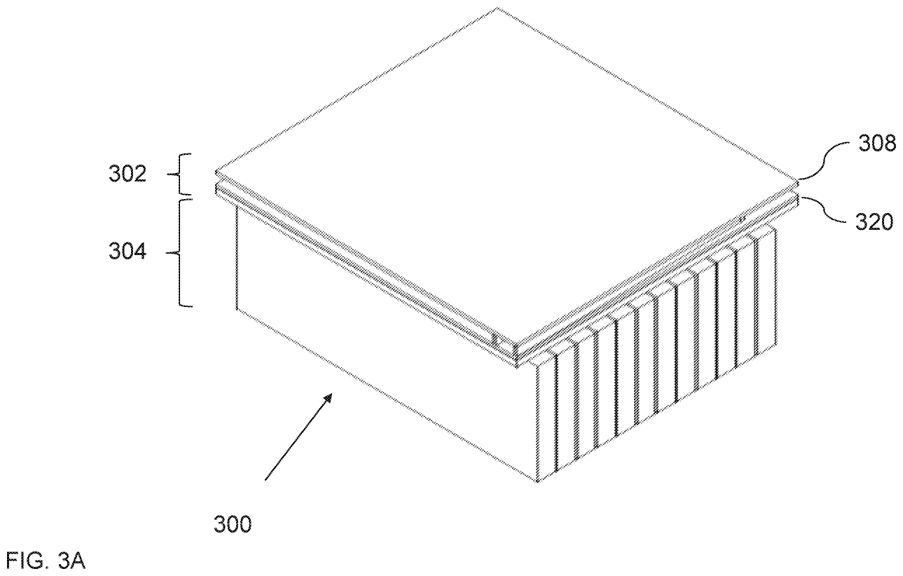

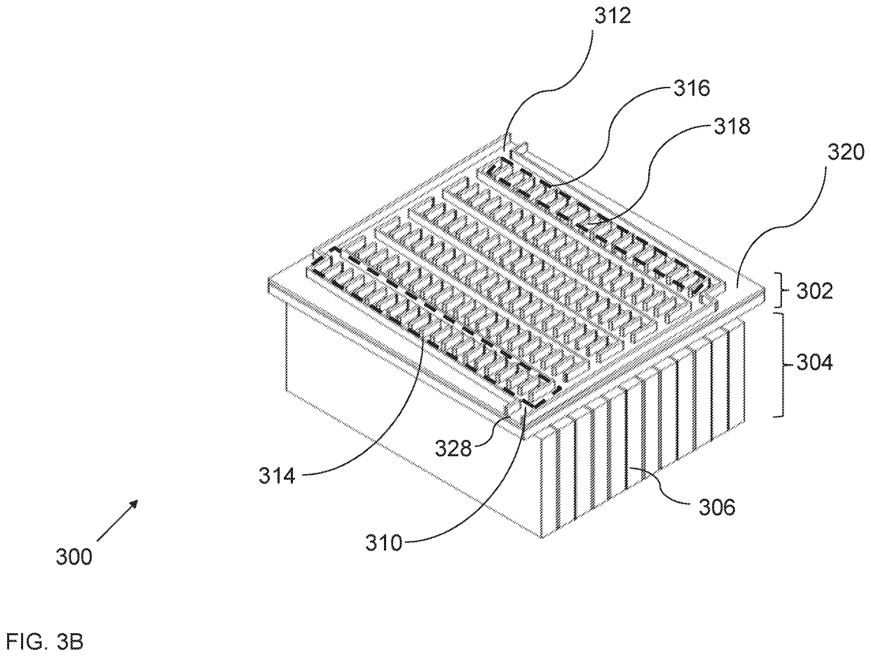

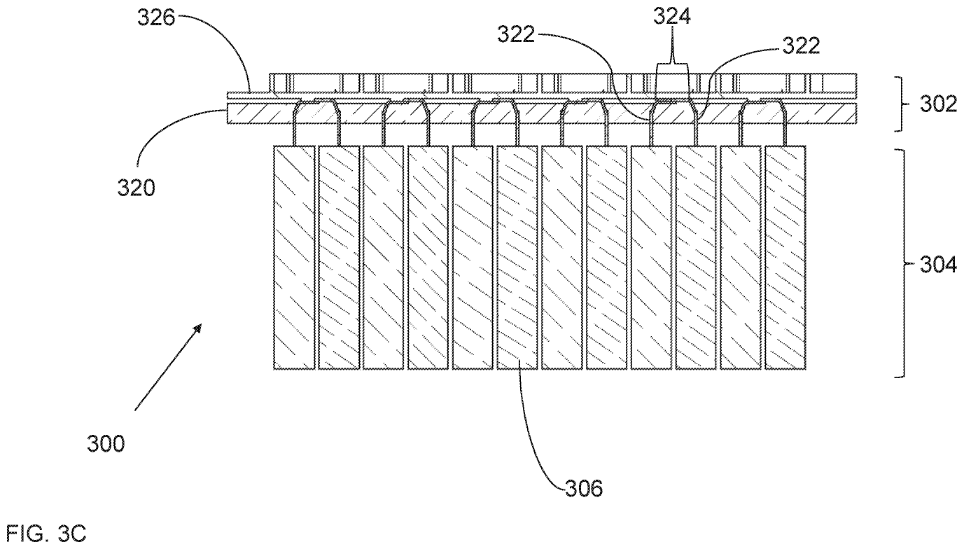

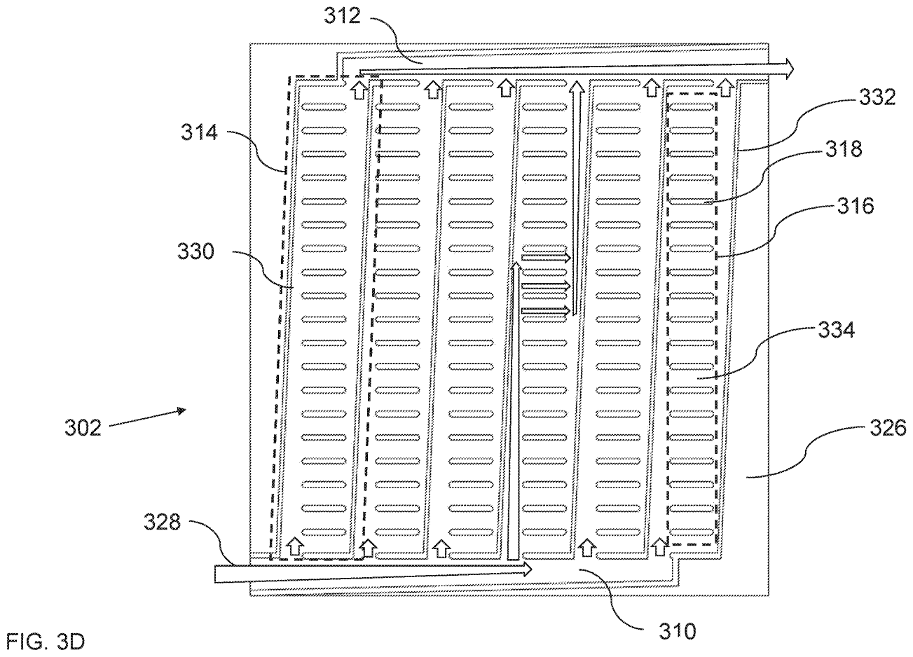

FIG. 3A is perspective view of a battery and cooling system in accordance with a third embodiment of the present invention;

FIG. 3B is further perspective view of the battery and cooling system in in FIG. 3A with the upper cover removed;

FIG. 3C is side-on cross-sectional view of the battery and cooling system in accordance with the third embodiment of the present invention;

FIG. 3D is a plan view of the battery and cooling system in FIG. 3B;

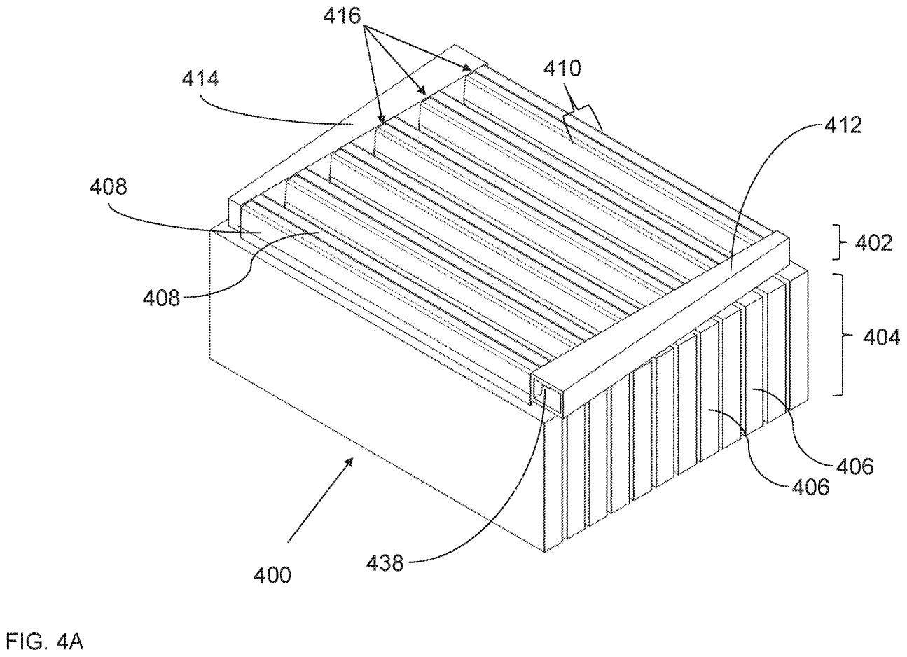

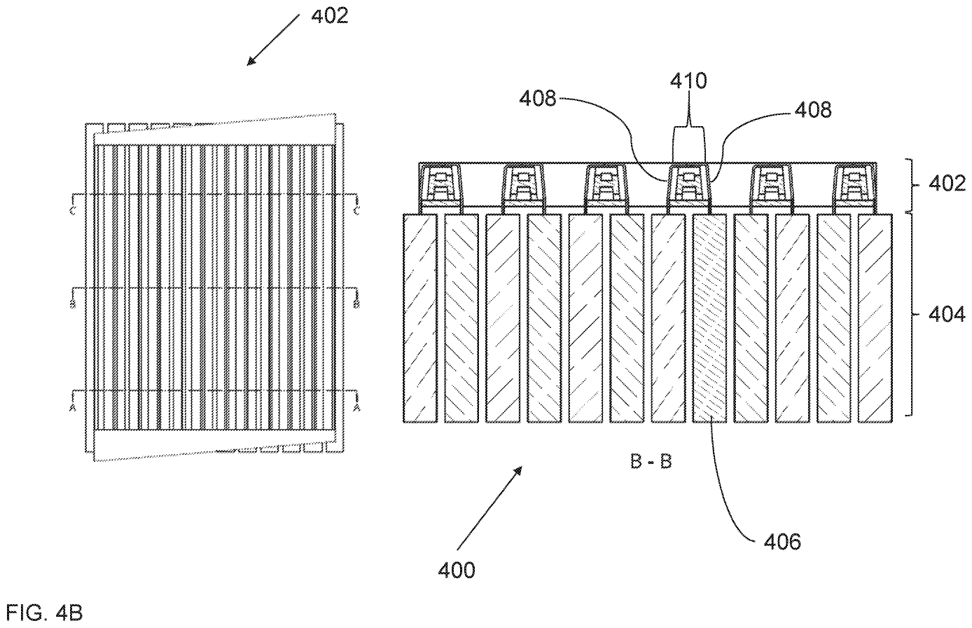

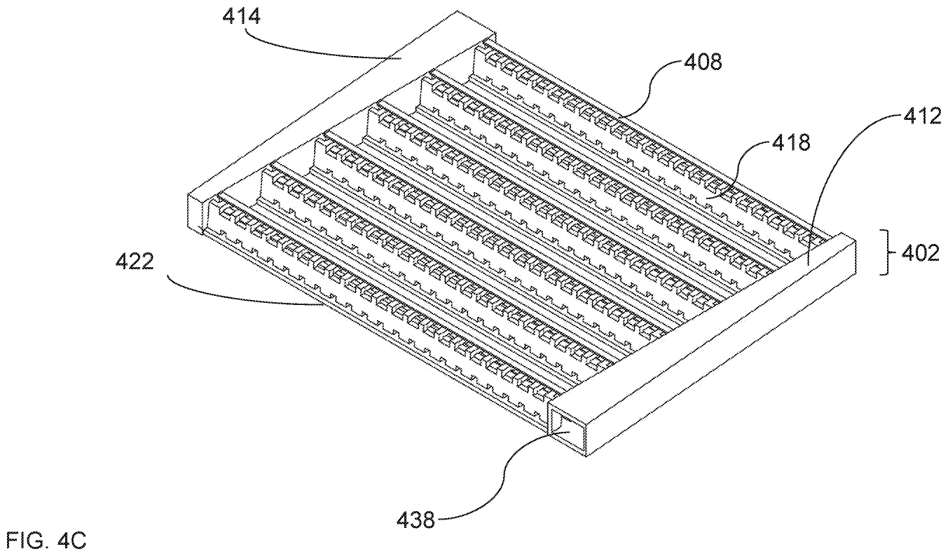

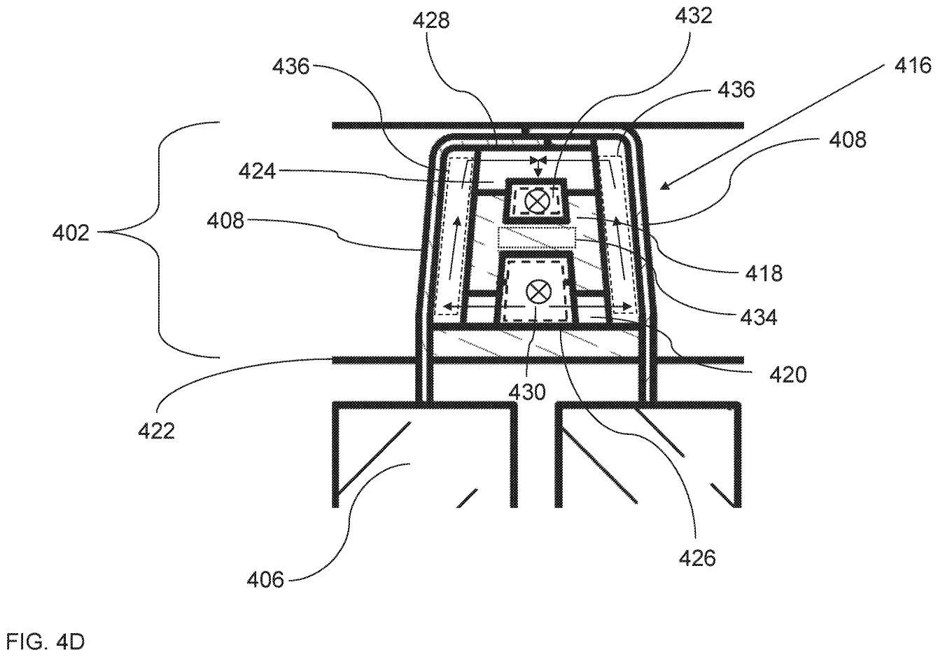

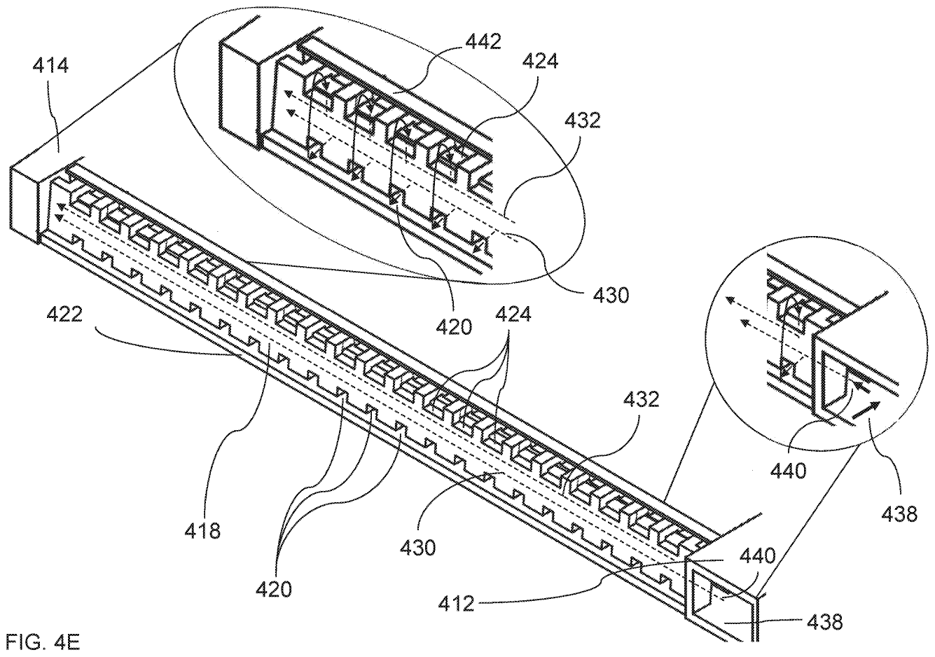

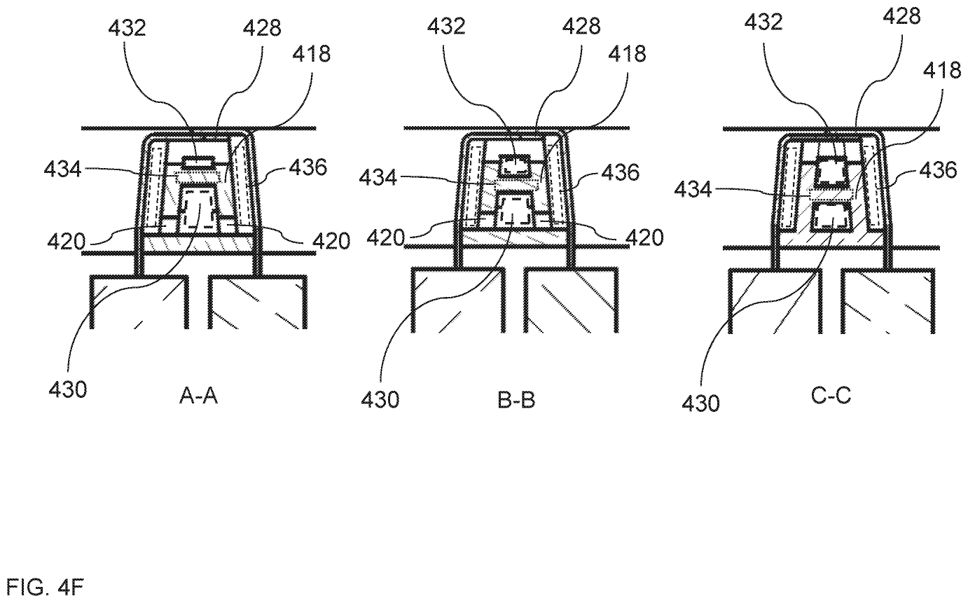

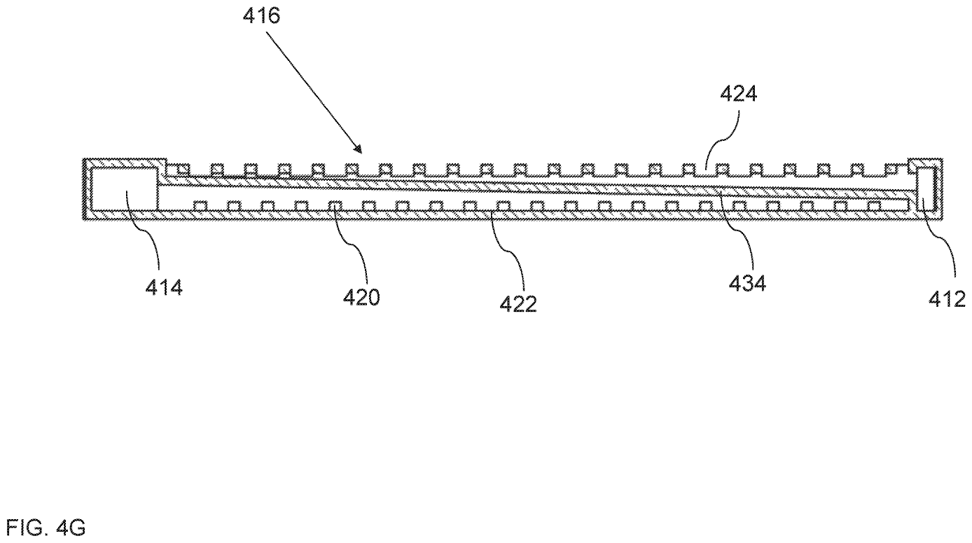

FIG. 4A is a perspective view of a battery and cooling system in accordance with a fourth embodiment of the present invention;

FIG. 4B is a plan view and a side-on cross-sectional view of the battery and cooling system in accordance with the fourth embodiment of the present invention along the line B-B;

FIG. 4C is a perspective view of the heat sink arrangement in accordance with the fourth embodiment of the present invention with some of the terminals omitted;

FIG. 4D is an enlarged side-on cross-sectional view of a cooling channel in accordance with the fourth embodiment of the present invention;

FIG. 4E is a perspective view of the heat sink arrangement in accordance with the fourth embodiment of the present invention with enlarged portions;

FIG. 4F is a view similar to FIG. 4D showing cross-sectional views of a cooling channels at three different points along its length;

FIG. 4G, is an enlarged side-on cross-sectional view of a cooling channel in accordance with the fourth embodiment of the present invention;

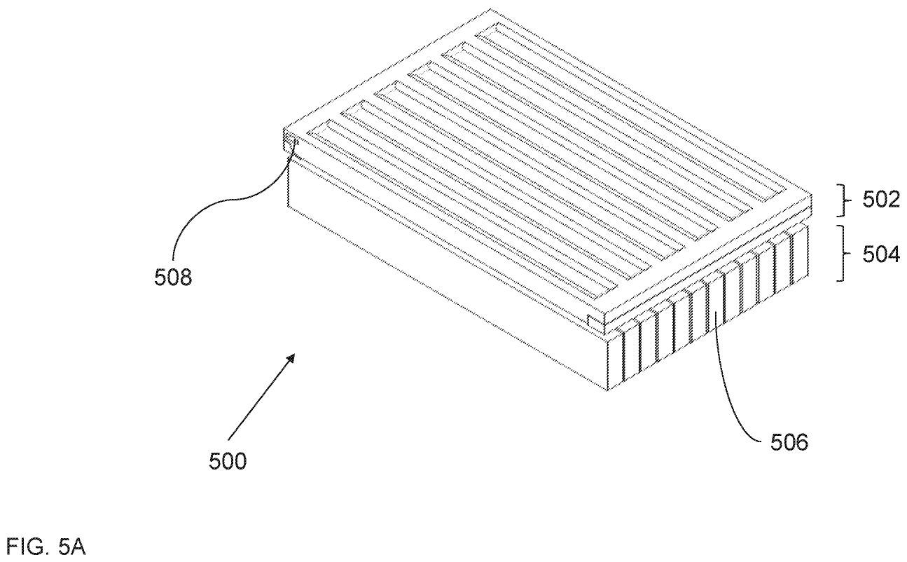

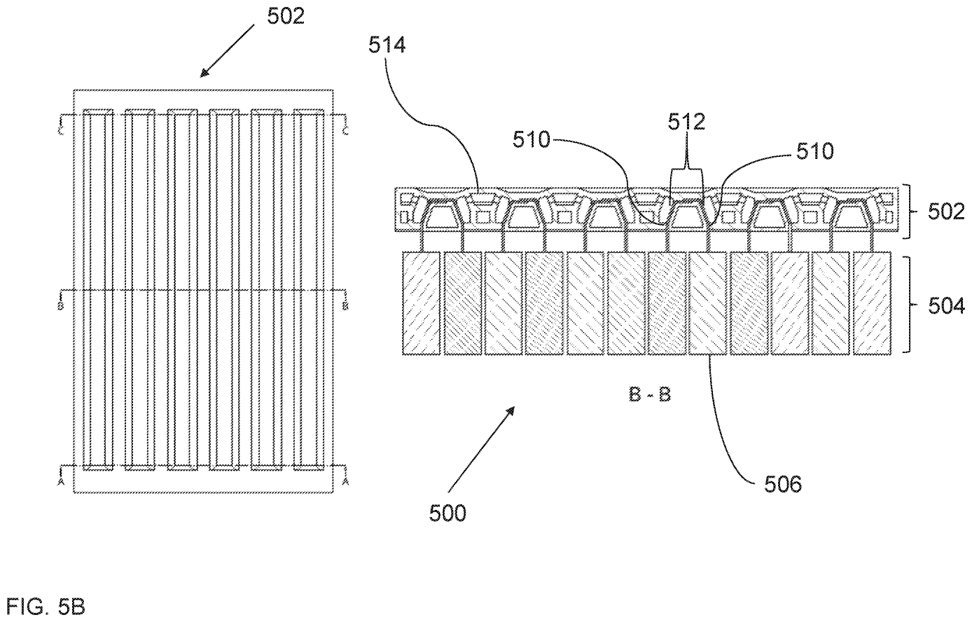

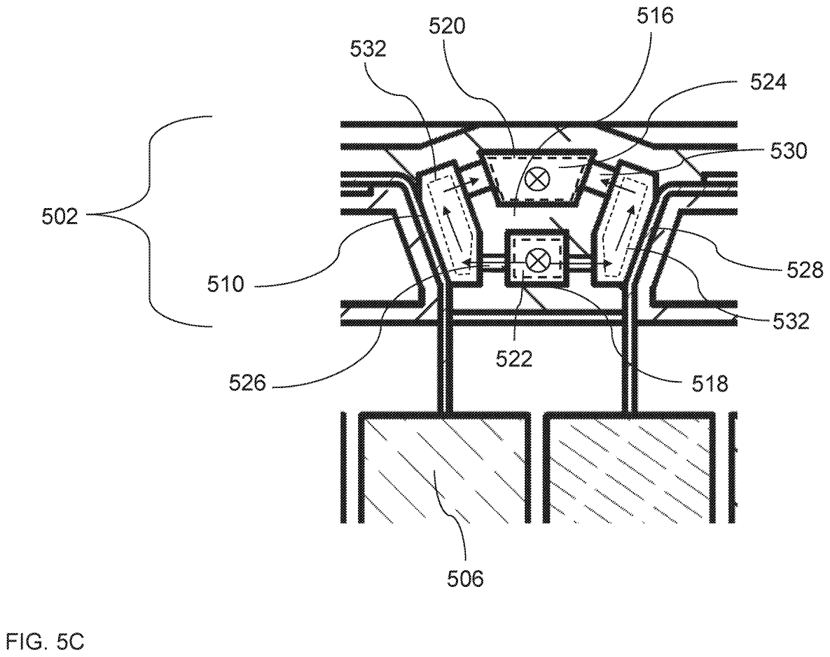

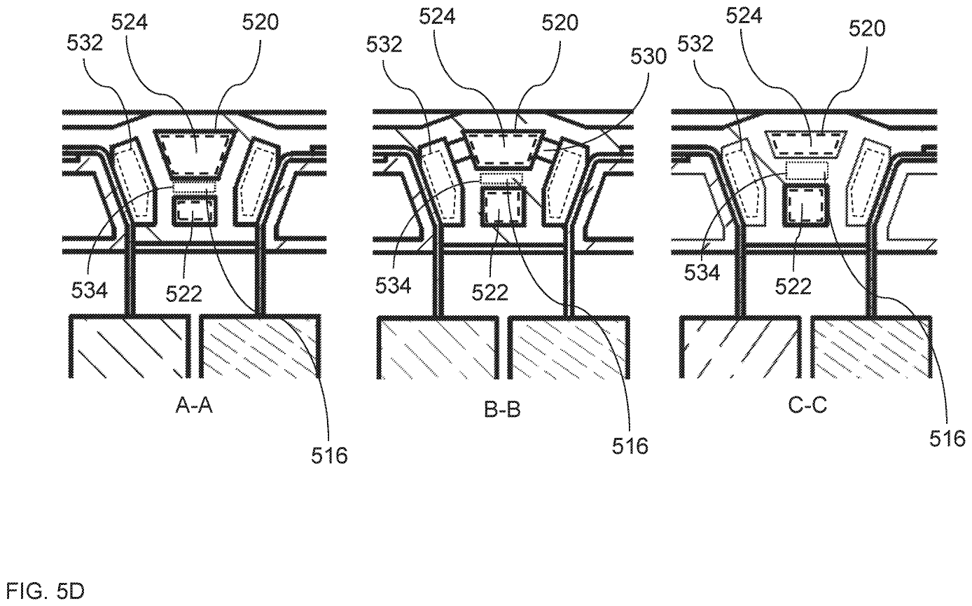

FIG. 5A is a perspective view of a battery and cooling system in accordance with a fifth embodiment of the present invention;

FIG. 5B is a plan view and a side-on cross-sectional view on the line B-B of the battery and cooling system in accordance with the fifth embodiment of the present invention;

FIG. 5C is a side-on cross-sectional view of a cooling channel in accordance with the fifth embodiment of the present invention; and

FIG. 5D is a view similar to FIG. 5C showing cross-sectional views of the cooling channel at three different points along its length.

Whilst it should be understood that the invention as described herein can be used for either cooling or heating of a battery (or both), in the specific embodiments described below, only cooling is used. However, this should not be construed as limiting.

FIG. 1A show a perspective view of a battery and cooling system 100 in accordance with a first embodiment of the present invention. A heat sink arrangement 102 is mounted to a battery 104, where the battery 104 comprises a plurality of mutually adjacent stacked cells 106. Of course, in accordance with the present invention, the cells may be arranged such that they are connected in parallel or series. However, in the exemplary battery construction shown, terminals extending out of adjacent cells 106 have alternating polarity, such that when a cell is connected to the cell adjacent to it, they are connected in series.

In the embodiment shown in FIG. 1A, the heat sink arrangement is enclosed on one side by a top portion 108, and on the other side a base portion 110 is fitted onto the battery 104. As will be explained in more detail below, the heat sink arrangement 102 is positioned such that it can carry away heat which is generated by the battery, as a result of being in thermal contact with the terminals of each cell.

FIG. 1B shows a cross-sectional view of the first embodiment of the battery and cooling system 100 with the top portion 108 removed. Terminals 112 extend from each cell 106, and adjacent cells are electrically connected to one another via their terminals. The terminals from adjacent cells are physically in contact and bonded with one another. In the embodiment shown in FIG. 1B, the terminals from adjacent cells are bent over such that they overlap, and are bonded into contact with one another using a lap weld, forming a connected pair 114. Alternatively, the terminals could be bonded together with a butt weld, or edge weld (not shown). The terminals 112 extend through the base portion 110 of the heat sink arrangement, such that exposed portions 116 of the connected pairs of electrical terminals close and seal corresponding openings in the base portion 110. As will be explained below, the exposed portion 116 of each connected pair of terminals 114 can therefore be directly cooled by a flow of coolant fluid through the heat sink arrangement 102 to maximise heat transfer.

FIG. 1C is a perspective view of the first embodiment of the battery and cooling system 100, with the top portion 108 removed. The heat sink arrangement 102 has an inlet channel 120, an outlet channel 122, and a plurality of cooling channels 124 extending between the inlet and outlet channels. The inlet channel 120 has a cross-sectional area which decreases with distance away from the inlet opening 134. Each cooling channel 124 is bounded by a respective inflow wall 126 and outflow wall 128, and a permeable barrier 130 is located within each cooling channel. (Accordingly, for a series of cooling channels next to each other, the inflow wall 126 of one channel can also be the outflow wall 128 of the adjacent channel). The permeable barriers 130 are slanted with respect to the inflow wall 126 and outflow wall 128 of each cooling channel. This results in the space between the inflow wall 126 and the permeable barrier 130 being largest at the inlet to each cooling channel (at the end proximate the inlet channel), and decreasing with distance toward the outlet channel. In this first embodiment, the permeable barrier 130 is formed of a plurality of protrusions 132, with passageways 138 between the protrusions 132. The exposed portions 116 of the connected pairs of terminals referred to above are aligned with the permeable barriers 130 such that they form the part of the base portion 110 at the bottom of each of the passageways 138.

FIG. 1D is a plan view of the first embodiment of the heat sink arrangement 102 with the top portion 108 removed. Arrows show the flow of coolant fluid through the structure. Coolant fluid enters the heat sink arrangement 102 at the inlet opening 134 of the inlet channel 120, before flowing along the inlet channel. The reducing cross sectional area of the inlet channel 120 results in a substantially equal mass of coolant fluid being distributed into each of the cooling channels 124, because the tapering cross-section of the channel matches the reduction of the mass of coolant fluid in the inlet channel 120 as equal amounts flow into the cooling channels.

Distributing an even mass of fluid into each cooling channel 124 means that the same capacity for cooling is delivered to each of the cells of the battery. This is advantageous to prevent temperature gradients appearing across the battery. This reduces the need for early replacement of the battery due to failure or fatigue of only some of the cells in the system.

A similar principle then applies within each cooling channel 124. As a result of the permeable barriers 130 being slanted relative to the inflow walls 126, coolant fluid is distributed evenly along each permeable barrier 130 before flowing through them, such that a substantially equal mass of coolant fluid passes through each passageway 138.

The fluid delivered to each passageway 138 within the heat sink arrangement 102 should have substantially equal mass, and substantially equal temperature. This reduces temperature gradients across each cell, which may arise in a heat sink arrangement where there are no permeable barriers 130 situated within the cooling channels 124. In a conventional arrangement, coolant fluid would be delivered to the end of each cooling channel 124 proximate the inlet channel 120 at a lower initial temperature, and the fluid would increase in temperature as it flowed along the length of each cell's terminals toward the outlet channel 122. As a result, the temperature difference between the coolant fluid and the terminals 112 of cells would be smaller at the end of the cooling channels proximate the outlet channel 122. This means a reduced heat transfer capacity of the fluid, and by consequence, uneven cooling along each cell. The heat sink arrangement 102 promotes uniform cooling by addressing this problem.

FIGS. 2A and 2B show a second embodiment of the battery and cooling system 200. This differs from the first embodiment in that the enclosed top portion is replaced with a second, mirror set of cells which are cooled. Thus, the heat sink arrangement 202 provides cooling to a first set of cells 204 (in the same manner as shown in FIGS. 1B-D), and also provides cooling to a second set of cells 206 on the other side of the heat sink arrangement 202.

FIG. 2B is a cross-sectional view of the second embodiment 200. The first set of cells 204 are configured as they were for the first embodiment 100, as shown in FIG. 1B. In FIG. 2B, cells are therefore connected in series. However, as was the case for the first embodiment, the terminal connections as shown in FIG. 2B could be adapted to form a parallel connection instead in an alternative set of embodiments. In FIG. 2B, a second set of terminals 208 extend from each cell 210 in the second set of cells 206, where adjacent cells are electrically connected to one another via their terminals 208 forming connected pairs 212. The terminals 208 extend through the top portion 214 of the heat sink arrangement 202, such that exposed portions 216 of connected pairs of electrical terminals 212 close and seal corresponding openings in the top portion. The exposed portion 216 of each connected pair of terminals 212 can therefore also be directly cooled by the same flow of coolant fluid through the heat sink arrangement 202 which cools the first set of cells 106.

FIG. 3A show a perspective view of a battery and cooling system 300 in accordance with a third embodiment of the present invention. In a similar manner to the first embodiment, a heat sink arrangement 302 is coupled to a battery 304 of mutually adjacent stacked cells 306. As shown in FIG. 3B with the top portion 308 removed, the heat sink arrangement 302 comprises an inlet channel 310, outlet channel 312, and a plurality of cooling channels 314. As before, the inlet channel 310 has a cross-sectional area which decreases with distance away from the inlet opening 328, and the slanted permeable barrier 316 in each cooling channel 314 is formed of a plurality of protrusions 318. However, in this third embodiment 300, the base portion 320 is closed and shaped such that it conforms to and fits over the terminal pairs 324 extending from the top of the cells 306, as can be seen in FIG. 3C.

FIG. 3C is a side-on cross-sectional view of the third embodiment 300 of the battery and cooling system with the top portion 308 removed. As was the case for all previous embodiments, the terminals 322 from adjacent cells form connected pairs 324, but as described with respect to FIG. 3A, the closed base portion 320 of the third embodiment is shaped to fit over the top of connected pairs of electrical terminals 324. In an alternative set of embodiments not shown, the base portion 320 could be flat, with a thermally conductive gap filler material used to fill the space between the base portion 320 and the battery, connecting the two. Indeed, a thermally conductive filler material could also be used in conforming embodiments like that shown. Although having the base portion closed adds an extra layer of material compared to the direct contact of coolant fluid on the terminals in the first two embodiments, this arrangement allows the heat sink arrangement 302 to be more easily removable, and potentially fitted with a wider range of battery arrangements.

FIG. 3D is a plan view of the third embodiment 300 of the heat sink arrangement 302 with the top portion 108 removed. In the same manner as the first embodiment, the inlet channel 310 has a cross-sectional area which decreases with distance away from the inlet opening 328, and, the permeable barriers 316 are slanted with respect to the inflow wall 330 and outflow wall 332 of each cooling channel 314. Accordingly, as for the first embodiment, a substantially equal mass of coolant fluid is distributed into each of the cooling channels 314, and a substantially equal mass of coolant fluid passes through each passageway 334 along the permeable barriers 316.

However, in the third embodiment, the coolant fluid does not come into direct contact with the electrical terminals 322. The upper surface 326 of the base portion of the heat sink arrangement 302 is made of a material such that it is conductive to heat, and as shown in FIG. 3C, is shaped to fit over the electrical terminals 322 aligned underneath each permeable barrier. Optionally a thermally conductive filler material could also be used. Consequently, as coolant fluid passes through the permeable barriers, it conducts heat away from the electrical terminals 322.

FIG. 4A show a perspective view of a battery and cooling system 400 in accordance with a fourth embodiment of the present invention. A heat sink arrangement 402 is coupled to a battery 404 of mutually adjacent stacked cells 406. The heat sink arrangement 402 has an inlet channel 412, an outlet channel 414, and a plurality of cooling channels 416. In this fourth embodiment, the cooling channels 416 are located between connected pairs of terminals 410, such that each electrical terminal 408 extends from a cell 406 and forms a side wall of a cooling channel 416.

FIG. 4B shows a cross-sectional side-on view of the battery and cooling system 400, and a plan view of the heat sink arrangement 402. The location of the cross-sectional view is indicated by the section line B-B in the plan view.

FIG. 4C is a perspective view of the fourth embodiment of the battery and cooling system 400, with one electrical terminal 408 of each connected pair 410 removed to show the structure of the slanted permeable barrier 418 inside.

As can be seen in FIGS. 4B and 4C, in the fourth embodiment, the permeable barrier 418 is located in each cooling channel 416 between the connected pairs of terminals 410. Thus, the terminals 408 themselves provide an integral structural part of the heat sink arrangement 402, rather than the cooling channels 416 being defined between walls provided on a separate heat sink arrangement structure. In the cross-sectional view of FIG. 4B, it can be seen that a connected pair of electrical terminals 410 from adjacent cells, form three sides of a cooling channel 416.

FIG. 4D shows a cross-sectional view (section B) of one of the cooling channels 416 in the battery and cooling system 400. The cooling channel 416 comprises an inflow wall 426 and an outflow wall 428 on either side of the permeable barrier 418. One of the electrical terminals 408 forms part of the outflow wall 428, with an upper surface of a base portion 422 of the cooling channel 416 forming the inflow wall 426. An inflow space 430 is defined between the inflow wall 426 and the permeable barrier 418, and an outflow space 432 is defined between the outflow wall 428 and the permeable barrier 418. Inflow passageways 420 and outflow passageways 424 through the permeable barrier are periodically spaced along the length of the permeable barrier. Elongate intermediate chambers 436 are formed along the left and right sides of the cooling channel 416. These are bounded by the base portion 422, the electrical terminals 408 and the permeable barrier 418.

FIG. 4E is a perspective view of one of the cooling channels in the fourth embodiment. A series of longitudinally spaced inflow passageways 420 can be seen along the permeable barrier 418, adjacent to the base portion 422 of the cooling channel. Outflow passageways 424 are located adjacent to the overlapping portion of the connected pair of electrical terminals 410.

With reference to the arrows shown in FIGS. 4D and 4E, coolant fluid flows through the heat sink arrangement 402 as described below. Coolant fluid enters the inlet channel 412 at the inlet opening 438, and a respective portion of the coolant fluid is distributed into each cooling channel 416 at its respective inlet 440 and into the inflow space 430 of that cooling channel.

In each cooling channel 416, a portion of the coolant fluid passes from the inflow space 430 beneath the permeable barrier 418 through the inflow passageways 420 on either side of the permeable barrier 418 and spaced along the cooling channel. As the coolant fluid passes through the inflow passageways it passes into the elongate intermediate chambers 436 running along the left and right edges of the cooling channel 416. The coolant fluid thus directly impinges on the surfaces of the electrical terminals 408 which form the side walls of the cooling channel. The coolant fluid then flows back through the outflow passageway 424 into the outflow space 432 above the permeable barrier and form there into the outlet channel 414, in the direction indicated by the arrows in FIGS. 4D and 4E.

The slanting of the permeable barrier 418 from the inlet end to the outlet end may be seen in FIG. 4F which shows a cross-sectional view of a cooling channel 416 of the battery and cooling system 400 at three sections along the length of the cells. The section A-A is located at the end of the cooling channel 416 proximate the inlet of the heat sink arrangement 402, section B-B is located at the centre of the cooling channel 416, and section C-C is located at the end of the cooling channel 416 proximate the outlet of the heat sink arrangement C-C. As was the case for the previous embodiments, the permeable barrier 418 is slanted within the cooling channel 416. because the position of the horizontal section 434 of the permeable barrier 418 changes along the length of the cooling channel so that it is closest to the outflow wall 428 at the inlet to the cooling channel 416, and furthest from the outflow wall 428 at the end of the cooling channel proximate the outlet of the heat sink arrangement 402. The slanting of the horizontal section 434 of the permeable barrier 434 can be further seen in FIG. 4G, which shows a side-on cross-sectional view through one of the cooling channels 416.

As a result, as shown in FIG. 4F, the cross-sectional area of the inflow space 430 is largest in section A-A, and reduces along the length of the cooling channel, such that it is smallest in section C-C. Equally, the cross-sectional area of the outflow space 432 is smallest in section A-A, and largest in section C-C. This produces the same effect as the other embodiments of the invention, i.e. the mass of coolant fluid in the inflow space 430 incrementally decreases by a uniform amount along its length, and the mass of coolant fluid in the outflow space 432 incrementally increases as the cumulative mass of coolant fluid that has passed through the permeable barrier 418 increases along the length of the cooling channel 416. The coolant fluid is consequently distributed evenly along each permeable barrier 418 before flowing through it, such that a substantially equal mass of coolant fluid, at a substantially equal temperature, passes through each inflow passageway 420 and is provided to the surfaces of the electrical terminals 408 which form the side walls of the cooling channels 416.

FIG. 5A shows a perspective view of a battery and cooling system 500 in accordance with a fifth embodiment of the present invention. A heat sink arrangement 502 is coupled to a battery 504 of mutually adjacent stacked cells 506. The heat sink arrangement 502 has an inlet opening 508 for receiving a coolant fluid.

FIG. 5B shows a cross-sectional side-on view of the battery and cooling system 500 and plan view of the heat sink arrangement 502. The location of the cross-sectional view is indicated by the section line B-B in the plan view. As is the case for other embodiments described above, terminals 510 from adjacent cells form connected pairs 512. The terminals 510 extend through the heat sink arrangement 502, such that the connected pair of electrical terminals form part of the internal structure of the heat sink arrangement 502.

FIG. 5C shows a cross-sectional view (section B) of a cooling channel 514 in the battery and cooling system 500. For each cooling channel 514, an electrical terminal 510 of a connected pair 512 forms one side wall of the cooling channel, and an electrical terminal 528 of an adjacent connected pair forms a second wall of the cooling channel. In this fifth embodiment, each cooling channel 514 is therefore shared between two connected pairs of terminals. The cooling channel 514 comprises a permeable barrier 516, inflow wall 518 and outflow wall 520. An inflow space 522 is defined between the inflow wall 518 and the permeable barrier 516 and an outflow space 524 is defined between the outflow wall 520 and the permeable barrier 516. Inflow passageways 526 and outflow passageways 530 through the permeable barrier are periodically spaced along its length.

In a similar manner to the fourth embodiment, and as shown by the arrows in FIG. 5C, coolant fluid is distributed between cooling channels 514, and initially enters each cooling channel 514 in the inflow space 522 formed below the permeable barrier 516 at the end proximate the inlet of the heat sink arrangement 502. At periodic points along the length of each cooling channel, a portion of the coolant fluid passes from the inflow space 522 through a pair of inflow passageways 526 on either side of the permeable barrier, into respective left and right intermediate chambers 532 such that the coolant fluid directly impinges on the surface of the electrical terminals (510, 528) which form the side walls of the cooling channel. After impinging on the terminals 510, 528, the coolant fluid then flows through outflow passageway 530 into the outflow space 524 formed below the permeable barrier, in the direction indicated by the arrows. The used coolant fluid then flows through the outflow space 524 to the outlet of the heat sink arrangement 502.

FIG. 5D shows a cross-sectional view of a cooling channel 514 at three sections along the length of the cells. The section A-A is located at the end of the cooling channel 514 proximate the outlet of the heat sink arrangement 502, section B-B is located at the centre of the cooling channel 514, and section C-C is located at the end of the cooling channel 514 proximate the inlet of the heat sink arrangement. As was the case for the previous embodiments described above, the permeable barrier 516 is slanted within the cooling channel 514. The slanted configuration means that the horizontal section 534 of the permeable barrier 516 is closest to the outflow wall 520 at the inlet to each cooling channel 514, and furthest from the outflow wall 520 at the end of the cooling channel proximate the outlet of the heat sink arrangement 502.

As a result, the cross-sectional area of the inflow space 522 is largest in section C-C, and reduces along the length of the cooling channel, such that it is smallest in section A-A. Equally, the cross-sectional area of the outflow space 524 is smallest in section C-C, and largest in section A-A. This produces the same effect as the other embodiments of the invention, i.e. the mass of coolant fluid in the inflow space 522 incrementally decreases by a uniform amount along its length, and the mass of coolant fluid in the outflow space 524 incrementally increases as the cumulative mass of coolant fluid that has passed through the permeable barrier 516 increases along the length of the cooling channel 514. Thus, the fifth embodiment also achieves uniform cooling across the battery on account of a slanted permeable barrier 516.

In a sixth embodiment of the present invention (not shown), the embodiment shown in FIGS. 5A-5D may be adapted, such that the intermediate chambers 532 are merged with the outflow space 524. This removes the portion of the permeable barrier 516 which provides the outflow passageways 530. This is because, while the inflow passageways 526 are beneficial to create jets and perform impingement onto the surface of the terminals 510, 528, the outflow passageways perform the less important function of helping to distribute the flow into the outflow space. This sixth embodiment may advantageously reduce the complexity of the construction of the permeable barrier 516 in the cooling channel 514.

It will be appreciated by those skilled in the art that the invention has been illustrated by describing one or more specific embodiments thereof, but is not limited to these embodiments; many variations and modifications are possible, within the scope of the accompanying claims. For example, as outlined above, the principles of the invention may be used in applications where batteries need to be heated, either in addition to or instead of being cooled as in the specific embodiments described.

1. A battery and thermal management system comprising a battery and a heat transfer arrangement, the battery comprising a plurality of mutually adjacent cells, each of said cells comprising an electrical terminal extending therefrom, adjacent pairs of said terminals being electrically connected together to form a connected pair;
the heat transfer arrangement comprising:
an inlet channel,
an outlet channel, and
a plurality of heat transfer channels defined between respective inflow walls and outflow walls, wherein the heat transfer channels extend between the inlet channel and the outlet channel; each heat transfer channel further comprising a respective permeable barrier therein, the permeable barriers being slanted relative to the corresponding inflow and outflow walls so as to be positioned furthest from the inflow wall at a first end of the respective heat transfer channel proximate the inlet channel, and closest to the inflow wall at a second end of the respective heat transfer channel proximate the outlet channel; and,
wherein each permeable barrier is in thermal contact with a respective connected pair of terminals along a length of the permeable barrier.

2. The battery and thermal management system of claim 1, further comprising a pumping system arranged to pump a heat transfer fluid through the heat transfer arrangement from the inlet channel to the outlet channel, through the heat transfer channels.

3. The battery and thermal management system of claim 1, wherein the heat transfer arrangement is arranged such that in use, substantially equal mass flows of a or the heat transfer fluid are distributed into each heat transfer channel.

4. The battery and thermal management system of claim 1, wherein the inlet channel comprises a cross-sectional area which varies between a maximum at a proximal end of the inlet channel and a minimum at a distal end of the inlet channel.

5. The battery and thermal management system of claim 1, wherein the outlet channel comprises a cross-sectional area which varies between a maximum at a proximal end of the outlet channel and a minimum at a distal end of the outlet channel.

6. The battery and thermal management system of claim 1, wherein at least one of the permeable barriers comprises a series of longitudinally spaced heat transfer features.

7. The battery and thermal management system of claim 6, wherein at least some of the heat transfer features comprise walls or protrusions, and a or the heat transfer fluid is made to flow through the space between adjacent protrusions.

8. The battery and thermal management system of claim 6, wherein at least some of the heat transfer features comprise holes.

9. The battery and thermal management system of claim 1, wherein the heat transfer channels are arranged such that in use, a heat transfer fluid comes into direct contact with a surface of the connected pairs of terminals.

10. The battery and thermal management system of claim 9, wherein the heat transfer fluid impinges substantially normally onto one or more of the terminal surfaces.

11. The battery and thermal management system of claim 9, wherein for each heat transfer channel, an electrical terminal of a connected pair forms a first wall of the heat transfer channel, and an electrical terminal of an adjacent connected pair forms a second wall of the heat transfer channel.

12. The battery and thermal management system of claim 9, wherein for each heat transfer channel, the first electrical terminal of a connected pair forms a first wall of the heat transfer channel and the second electrical terminal of the same connected pair forms a second wall of the heat transfer channel.

13. The battery and thermal management system of claim 9, wherein each connected pair of terminals extends through a base portion of the heat transfer arrangement such that the connected pair forms a portion of a base wall of each heat transfer channel.

14. The battery and thermal management system of claim 1, wherein the heat transfer arrangement comprises a base portion with an outer wall that the connected pairs of terminals do not extend through.

15. The battery and thermal management system of claim 14, wherein the outer wall of the base portion is shaped to fit over the connected pairs of terminals.

16. The battery and thermal management system of claim 14, wherein a thermally conductive gap-filling material is used to provide thermal contact between the connected pairs of terminals and the base portion.
